(19) United States
(12) Patent Application Publication
(10) Pub. No.: US 2015/0213434 A1
(43) Pub. Date: Jul. 30, 2015

(54) PRODUCT INFORMATION AND PAYMENT SYSTEM USING SCANABLE CODES

(71) Applicant: DCR STRATEGIES INC, Mississauge (CA)

(72) Inventors: Diana Fletcher, Mississauga (CA); Huguette Masse, Mississauga (CA)

(73) Assignee: DCR STRATEGIES INC, Mississauga (CA)

(21) Appl. No.: 14/423,331

(22) PCT Filed: Aug. 21, 2013
(86) PCT No.: PCT/CA2013/000731

§ 371 Date: Feb. 23, 2015

(30) Foreign Application Priority Data
Aug. 21, 2012 (CA) 2,787,817

(51) Int. Cl. G06Q 20/32; G06Q 30/02

(52) U.S. Cl. CPC G06Q 20/3276; G06Q 30/0226

(57) ABSTRACT

The present invention is a computer-based system for retrieving and displaying product information, and for purchasing products, by scanning a customized optical machine-readable representations of data, such as a QR code. The system supports products from multiple vendors and maintains a central database in which a user accumulates points by purchasing products associated with the customized codes. The customized codes contain a known identifier to indicate that they are special codes for processing by the system, as well as a product identifier and a vendor identifier.

### FIELD OF THE INVENTION

The present invention relates generally to online payment systems, and more particularly to systems for paying for items based on scanning optical machine-readable representations of data associated with the items using a mobile device.

### BACKGROUND OF THE INVENTION

Products and services are frequently purchased over the interne by users using a web browser on a computer or mobile computing device. Typically, the user identifies a product on a vendor's website and adds the product to the user's shopping cart. When the user has added all the items the user wishes to purchase to the cart, the user generally clicks on a “checkout” button or link to go to a payment screen where the user enters payment and delivery information, such as the user's credit card number and address.

In some cases, the payment and shipping information may be previously stored in the vendor's customer database and the user can have this information accessed automatically by signing into an account associated with the vendor so the user only needs to confirm that the purchase should be made using the payment and shipping information retrieved from the user vendor's database.

Mobile devices having cameras, such as smart phones, are now widely in use. Software applications exist that allow a user to scan a token, which may be a barcode, matrix barcode, or Quick Response (QR) code, associated with a product to extract a character string. Such strings may include a vendor-specific product code, or may include a uniform resource locator (URL) that the application opens in a browser on the mobile device. Generally, when a URL is encoded, the web page served from the URL will provide information about the particular product (or service) that the token was associated with. The token may be, for example, on the packaging of the product, on printed material near the product in a store, or in an advertisement that may be remote from the physical product.

While the user may be able to purchase a product whose token has been scanned by a mobile device, such purchases may be difficult to set up using the mobile device and generally require the user to directly interact with the particular vendor's website so that the user can provide the required payment and shipping information to the vendor.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

The present invention provides a code reader comprising a software application for running on a mobile device having a processor and having a user, for reading DCR tokens, a DCR token being an optical machine-readable representation of data having encoded therein a DCR identifier indicating that the token is a DCR token, a vendor identifier representing a particular vendor, a product identifier representing a product offered for sale by the vendor for a purchase price, and optionally a function specification, the software application being adapted to:
(a) decode a target token by processing a scan of the target token;
(b) determine whether the target token is a DCR token based on the presence or absence of the DCR identifier; and
(c) if the target token is a DCR token, then:
   (i) decode the vendor identifier, product identifier and function specification, if any; and
   (ii) if the function specification specifies that the product is to be purchased, then:
      access a remote user database to retrieve payment information, the payment information being sufficient for the user to make a payment;
      transmit the product identifier and payment information to the vendor associated with the vendor identifier to purchase the product associated with the product identifier; and
      add a number of points based on the purchased product to a points account of the user in the user database, wherein the points in the account are redeemable for cash, services or merchandise.

The mobile device may have a device identifier, the payment information in the user database may be indexed by the device identifier, and the software application may use the device identifier to retrieve the payment information from the user database. The device identifier may be a phone number of the mobile device.

If the function specification specifies that the product is to be purchased, then, prior to transmitting the payment information, the software application may retrieve the purchase price of the product, display the purchase price to the user, and obtain authorization to proceed from the user.

The DCR token may further encode the purchase price of the product, and the software application may retrieve the purchase price by decoding the DCR token, and authorize the vendor to obtain compensation equal to the purchase price using the payment information.

The software application may retrieve the purchase price of the product from a remote database, and authorize the vendor to obtain compensation equal to the purchase price using the payment information.

The number of points added to the account may be a monotonically increasing function of the purchase price.

After decoding the vendor identifier, product identifier and function specification, if there is no function specification or if the function specification specifies that product information should be retrieved, the software application may be further adapted to:
(d) retrieve product information associated with the vendor identifier and product identifier; and
(e) display the product information on the mobile device.

The product information may be retrieved from a remote product database. The product information may include the purchase price. The product information may be encoded in the DCR token and be retrieved by decoding the DCR token.

The DCR token may be a matrix barcode or a QR code.

The present invention also provides a system comprising the code reader described above and a token generator, the token generator comprising a software application for running on a vendor processor, the software application being adapted to generate DCR tokens having encoded therein a DCR identifier indicating that the token is a DCR token, a vendor identifier representing a particular vendor, a product identifier representing a product offered for sale by the vendor, and optionally a function specification that specifies either that product information should be retrieved or that the product is to be purchased by the user. The vendor processor may be contained in a computer system operated by the vendor whose vendor identifier is encoded in the generated DCR tokens.

After the code reader displays the product information on the mobile device, the code reader may provide an option for the user to purchase the product and, if the user chooses to purchase the product, then the code reader may:
(f) access the remote user database to retrieve payment information indexed by the device identifier, the information being sufficient for the user to make a payment;
(g) transmit the product identifier and payment information to the vendor associated with the vendor identifier to purchase the product associated with the product identifier; and
(h) add a number of points based on the purchased product to a points account of the user, wherein the points in the account are redeemable for cash, services or merchandise.

The code reader may provide an option to the user to place the product into a shopping cart, wherein the shopping cart may contain other products offered for sale by the same vendor, and may give the user the option to check out, so that if the user chooses to check out, the code reader then may:
(f) access the remote user database to retrieve payment information indexed by the device identifier, the payment information being sufficient to make a payment;
(g) transmit the product identifiers for all products in the shopping cart and payment information to the vendor associated with the vendor identifier to purchase the products associated with the product identifiers; and
(h) add a number of points based on the purchased products to a points account of the user, wherein the points in the account are redeemable for cash, services or merchandise.

The code reader may update the user database to record that the product has been purchased from the vendor.

If the token is not a DCR token, the code reader may indicate to the user the content of the QR code.

The present invention also provides computer-readable memories that have the code reader software application stored therein.

The present invention also provides computer-readable memories that have the token generator software application stored therein.

### BRIEF DESCRIPTION OF THE DRAWINGS

FIG. 1 depicts the major processing steps in a typical transaction involving a single product.

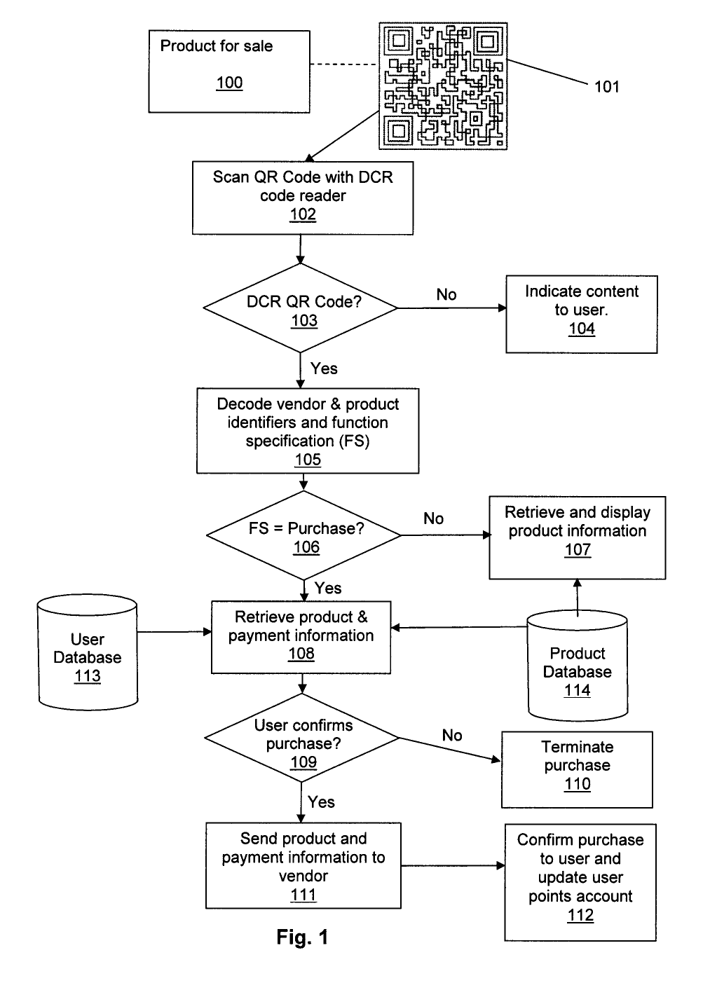

FIG. 2 depicts the context in which the code reader and code generator operate.

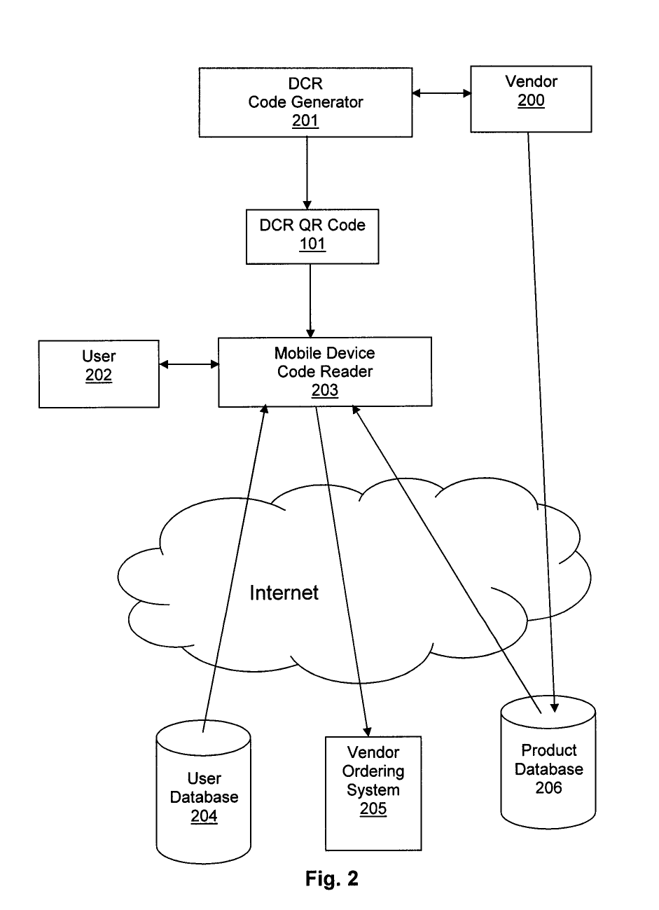

FIG. 3 depicts a sequence of events after a user scans a DCR QR code with a generic QR coder reader.

### DETAILED DESCRIPTION OF THE INVENTION

The present invention is an electronic payment system, for use with products offered by multiple vendors, that allows users (consumers) to accumulate points through purchasing products using the system, which points may be redeemed for cash, services or merchandise. Such accumulation of points is often used in loyalty programs. “Product” as used herein means any item available for purchase from a vendor, including all forms of goods and services that have an associated purchase price (which includes a rental price in case the product is offered for rental). The names of objects that are part of, or associated with, the system may be prefaced by “DCR”, where useful or necessary to distinguish the name from generic names. For example, the system employs optical machine-readable representations of data, or “tokens”, which are referred to herein as “DCR tokens” to distinguish them from generic barcodes or QR codes. Each DCR token has a DCR identifier encoded in it indicating that the token is a DCR token. The DCR identifier may be a known bit string for example, which might be generated by a cryptographic hash code generator to minimize the probability of it appearing in non-DCR QR codes.

The system relies on the widespread use of mobile device with cameras, such as smart phones and tablet computers. In all embodiments, the invention includes a DCR code reader, which is a software application that runs on a processor contained in such mobile devices, interacting with the user of the mobile device via displaying information on the screen and receiving input from the keyboard or touchscreen of the mobile device, and possibly also via the microphone and speaker, and indirectly through location sensing capabilities of the mobile device.

Optical machine-readable tokens in the form of matrix barcodes, and specifically QR codes, are often used in association with products offered for sale. For example, they may be placed on physical products or on packaging or signage associated with the products, or they may be placed in advertisements for a product, which may be remote from any actual products, such as in a magazine, in a newspaper, or on a billboard. An optical machine-readable token generally contains a character string encoded in it that can be decoded by a software application by processing a photograph of the token taken by a camera in a user's mobile device. The string may include instructions to display certain information to the user, or to open a browser window at a URL specified in the string, for example. The URL will typically be a website operated by the vendor or manufacturer of the product that provides information about the product, such as its price, specifications and availability. Some or all of this information may be encoded directly in the token.

Although a photograph is the preferred method to scan a token, other scanning methods may alternatively be employed. A “scan” of a token thereby includes a photograph of the token, but includes other digital representations of the contents of the token obtained by other scanning technologies, where suitable.

In general, when a user sees such a token, which is referred to as a “target token” herein, the user will not know if it is a DCR token. Consumers are becoming aware of target tokens in the form of QR codes, which are recognizable because of the pattern of three large squares and one small square in them, and many users have generic QR code readers installed on their mobile devices. Such code readers typically control the camera in the mobile device to allow the user to view a QR code on the mobile device's screen and move the device and zoom the image until it is the dominant aspect of the image on the screen and so that all of the QR code is on the screen, and then push a button to cause the reader to take a photograph of the QR code and extract the digital string that is encoded in it. Generally if a URL is part of the encoded digital string, the code reader will cause the mobile device's browser to go to that URL.

The present invention also includes a code generator to generate DCR tokens, which have encoded therein a DCR identifier, a vendor identifier representing a particular vendor, a product identifier representing a product offered for sale by the vendor for a purchase price, and optionally a function specification. The product identifier is an identifier that uniquely identifies the particular product offered for sale by the vendor corresponding to the vendor identifier. For example, a central authority, such as the system operator who provides the DCR code reader to users, may issue unique vendor identifiers to each vendor (which includes manufacturers, sales agents and advertising agents) of products that wishes to use DCR tokens to facilitate the retrieval of information about products they offer for sale or to actually purchase such products. The vendors may then assign product identifiers to each product they offer for sale, such that each product identifier corresponds to only one product offered by the vendor. In some cases, such as where the vendor wants to use DCR codes just to provide information about a product line, the product identifier could identify the entire product line, or family of products.

Each vendor then makes available to the system operator a database of information indexed by the product number that contains information about the corresponding product, such as the purchase price for products that are available for purchase. Vendors may maintain their own online product databases, or a central authority, such as the system operator, may maintain a product database, possibly with information about products offered by multiple vendors (indexed by both the vendor identifier and the product identifier) that is updated periodically or as it changes by the vendors. For example, the product database entry for a product identifier may contain product specifications and description, or a link to a website that includes such information, a purchase price, and availability information (e.g. available for immediate shipment, available at particular locations that are near the user's current location, or available for shipment in so many days).

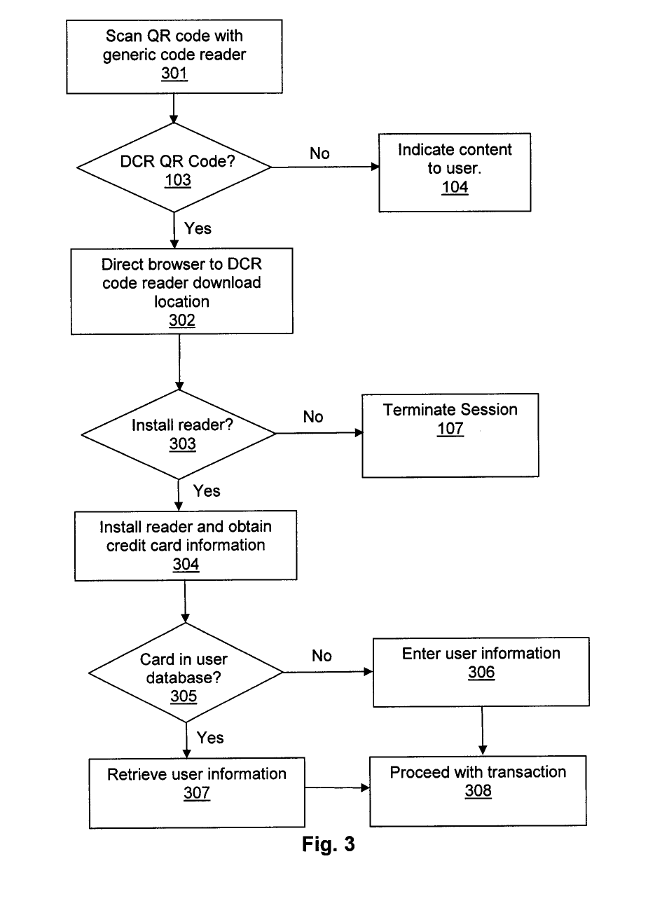

When a user scans a QR code with a mobile device using a generic code reader 301, as shown in FIG. 3, if the QR code is not a QR code 103, the usual action, indicating the content to the user 104, such as by displaying a web page at a URL encoded in the QR code, will be performed. If the code is a DCR QR code 103, then the user's mobile browser will be directed to a DCR code reader download location 302 which is a URL encoded in the DCR QR code, and the web page at that URL will ask the user whether the user wishes to install the DCR code reader 303. If the user declines, the session is terminated 107. If the user accepts, then the mobile device will download and install the DCR code reader, which will then run and obtain credit card information 204, such as a card type and number, from the user. After installation, the code reader may request that the user sign into an existing account, which already has credit card information associated with it, or request that the user provide a credit card number and related information.

If the user provides a credit card number, the reader can look up the number in a central user database 204 that includes payment information, such as a credit card type and number for registered users of the system. If the card is already in the database 305, the reader may retrieve the user's information 307 and proceed with a transaction 308, for example by asking the user to scan the DCR QR code again using the newly installed reader. If the card is not in the database 305, the reader may request that the user create an account and enter user information 306, such as the user's name, email address and shipping address, after which the user may proceed with a transaction 308.

For each user, the user database 113 includes a user record containing payment information that is sufficient for the user to make a purchase, such as one or more credit card numbers and ancillary information (such as card type, name on the card, expiration date and security code), and a shipping address. Each user record may further include one or more unique device identifiers that are associated with mobile devices on which the user has installed the DCR code reader. Examples of such device identifiers are a telephone number or a Media Access Control (MAC) address. Account information, such as a user identifier and password that allow the user to log into the system via a website may also be included in user records. Each user record also includes a points account, which includes at least the current total number of points that have been awarded by the system to the user that have not been cashed out.

In a preferred embodiment, after a user has the DCR code reader installed on the user's mobile device, a transaction is initiated by the user scanning a QR code with the DCR code reader 102 after the user identifies a QR code 101 associated with a product for sale 100 that the user either wishes to purchase or wishes to obtain more information about. The DCR code reader first determines whether the QR code is a DCR QR code 103 by decoding the code and determining whether the DCR identifier is present or absent in the code.

If the DCR identifier is absent, it is not a DCR QR code and the reader simply indicates the content of the code to the user 104, just as any generic QR code reader would do, for example by directing the mobile device's browser to an encoded URL. If the DCR identifier is present, the code is a DCR QR code and the reader will decode the vendor and product identifiers, and the functional specification (FS), if there is any such specification in the code. If there is no functional specification encoded, it may be assumed that the required function is to retrieve and display product information to the user 107. In this case, the function specification is implied, and “decoding” of the function specification in this case consists of determining that there is no function specification expressly encoded. Alternatively, this may be expressly encoded, or the functional specification may specify that the product for sale 100 is to be purchased 106. Other functions may alternately or additionally be encoded as functional specifications in DCR tokens.

If the required function is to retrieve and display product information to the user 107, the reader retrieves product information from a product database 114. This may be a database maintained by the vendor corresponding to the vendor identifier, or its agent, in which case the product identifier may be used to look up the product information. Alternatively, the information may be stored by the system operator in a central product database containing information on products for sale by multiple vendors, in which case both the vendor and product identifiers are used to look up the product information.

If the functional specification indicates that the product for sale 100 is to be purchased, then the DCR code reader retrieves product and payment information 108. The product information generally includes at least the purchase price (in currency or points), which is generally displayed to the user in order to have the user confirm that the purchase should proceed. The purchase price may be retrieved directly from the DCR QR code if it is encoded therein. More commonly, the purchase price will be retrieved from the product database 114. Payment and delivery information is retrieved from the user database. This normally includes a credit card number and ancillary information, and the user's shipping address in the case that the product is remote from the user.

If the user is collocated with the product, e.g. in a retail outlet, shipping information may not be required. After the user confirms the purchase 109, generally after having been presented with the purchase price and reviewing the shipping information, the reader sends the product and payment information to the vendor 111, and authorizes the vendor to obtain compensation equal to the purchase price using the payment information. This is generally sent to the vendor's payment server, which may be operated by an agent of the vendor, which confirms that the payment has been successful or not. After receiving confirmation of a successful purchase, the reader confirms the purchase to the user and updates the user's points account in the central user database. After receiving a response indicating that payment was not successful, the reader may ask the user to update the credit card information (such as the expiry date), to choose a different credit card stored in the user database, or to enter information for another credit card.

Points are awarded to users who purchase items associated with a DCR token. The points are accumulated in the user's points account and the user may be permitted to redeem the points for cash, services or merchandise via various mechanisms. Points are generally calculated as a monotonically increasing function of the purchase price, although the actual function may vary from vendor to vendor, product to product, and over time. The user may cash out some of the points in account, for example, by scanning a DCR token associated with a product that offers the user the option to purchase the product in exchange for a certain number of points. Then, if there are at least that many points in the user's points account, the user may confirm that the user wishes to purchase the product and the system will deduct the specified number of points from the user's points account. Alternatively, the user may log into a website provided by the system operator that allows the user to check on the number of points in the user's points account. The website may also provide information about what the user can do with the points, such as listing merchandise and the number of points required to purchase the merchandise, and allow the user to make such a purchase via the website if the user has a sufficient number of points in the points account. After such a purchase, the number of points associated with the purchased product are deducted from the user's points account.

In the case that the required function is to retrieve and display product information to the user, after retrieving and displaying the product information to the user, which normally includes the purchase price, the reader may provide an option for the user to purchase the product. If the user decides to purchase the product, the reader accesses the remote user database 113 to retrieve payment information indexed by the device identifier and then transmits the product identifier and payment information to the sales server of the vendor associated with the vendor identifier to purchase the product associated with the product identifier. After the server confirms that payment was accepted, the reader confirms the purchase to the user and adds a number of points based on the purchased product to a points account of the user.

The code reader may maintain a purchase history for each user in the user database by updating the user's record in the user database after product has been purchased from a vendor, with information such as the vendor and product identifiers, the purchase price paid, and the date and time of the purchase. Such information may be used by the system, for example, to identify user preferences so that, for example, targeted advertising could be presented to the user, which could be location based depending on the location information that is available from the mobile device.

Generally, a computer, computer system, computing device, client or server, as will be well understood by a person skilled in the art, includes one or more computer processors, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.). Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

It should be emphasized that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description as a whole.

1. A code reader comprising software running on a mobile device for reading DCR tokens, the mobile device having a processor and having a user, a DCR token being an optical machine-readable representation of data having encoded therein a DCR identifier indicating that the token is a DCR token, a vendor identifier representing a particular vendor, a product identifier representing a product offered for sale by the vendor for a purchase price, and a function specification, the software being configured to:
(a) decode a target token by processing a scan of the target token;
(b) determine whether the target token is a DCR token based on the presence or absence of the DCR identifier; and
(c) if the target token is a DCR token, then:
(i) decode the vendor identifier, product identifier and function specification; and
(ii) if the function specification specifies that the product is to be purchased, then:
access a remote user database to retrieve payment information, the payment information being sufficient for the user to make a payment;
transmit the product identifier and payment information to the vendor associated with the vendor identifier to purchase the product associated with the product identifier; and
add a number of points based on the purchased product to a points account of the user in the user database, wherein the points in the account are redeemable for cash, services or merchandise.

2. The code reader of claim 1, wherein the mobile device has a device identifier, the payment information in the user database is indexed by the device identifier, and the software application uses the device identifier to retrieve the payment information from the user database.

3. The code reader of claim 2, wherein the device identifier is a phone number of the mobile device.

4. The code reader of claim 1, wherein if the function specification specifies that the product is to be purchased, then, prior to transmitting the payment information, the software application retrieves the purchase price of the product, displays the purchase price to the user, and obtains authorization to proceed from the user.

5. The code reader of claim 4, wherein the DCR token further encodes the purchase price of the product, and the software application retrieves the purchase price by decoding the DCR token, and authorizes the vendor to obtain compensation equal to the purchase price using the payment information.

6. The code reader of claim 4, wherein the software application retrieves the purchase price of the product from a remote database, and authorizes the vendor to obtain compensation equal to the purchase price using the payment information.

7. The code reader of claim 1, wherein the number of points added to the account is a monotonically increasing function of the purchase price.

8. The code reader of claim 1, wherein, after decoding the vendor identifier, product identifier and function specification, if there is no express function specification or if the function specification specifies that product information should be retrieved, the software application is further configured to:
(d) retrieve product information associated with the vendor identifier and product identifier; and
(e) display the product information on the mobile device.

9. The code reader of claim 8, wherein the product information is retrieved from a remote product database.

10. The code reader of claim 8, wherein the product information includes the purchase price.

11. The code reader of claim 8, wherein the product information is encoded in the DCR token and is retrieved by decoding the DCR token.

12. The code reader of claim 1, wherein the DCR token is a matrix barcode.

13. The code reader of claim 12, wherein the DCR token is a QR code.

14. A system comprising the code reader of claim 1 and a token generator, the token generator comprising software running on a vendor processor, the software application being configured to generate DCR tokens having encoded therein a DCR identifier indicating that the token is a DCR token, a vendor identifier representing a particular vendor, a product identifier representing a product offered for sale by the vendor, and a function specification that specifies either that product information should be retrieved or that the product is to be purchased by the user.

15. The system of claim 14, wherein the vendor processor is contained in a computer system operated by the vendor whose vendor identifier is encoded in the generated DCR tokens.

16. The code reader of claim 8, wherein, after the code reader displays the product information on the mobile device, the code reader provides an option for the user to purchase the product and, if the user chooses to purchase the product, then the code reader:
(f) accesses the remote user database to retrieve payment information indexed by the device identifier, the information being sufficient for the user to make a payment;
(g) transmits the product identifier and payment information to the vendor associated with the vendor identifier to purchase the product associated with the product identifier; and
(h) adds a number of points based on the purchased product to a points account of the user, wherein the points in the account are redeemable for cash, services or merchandise.

17. The code reader of claim 8, wherein the code reader provides an option to the user to place the product into a shopping cart, wherein the shopping cart may contain other products offered for sale by the same vendor, and gives the user the option to check out, so that if the user chooses to check out, the code reader then:
(f) accesses the remote user database to retrieve payment information indexed by the device identifier, the payment information being sufficient to make a payment;
(g) transmits the product identifiers for all products in the shopping cart and payment information to the vendor associated with the vendor identifier to purchase the products associated with the product identifiers; and
(h) adds a number of points based on the purchased products to a points account of the user, wherein the points in the account are redeemable for cash, services or merchandise.

18. The code reader of claim 1, wherein the code reader updates the user database to record that the product has been purchased from the vendor.

19. The code reader of claim 13, wherein, if the token is not a DCR token, the code reader indicates to the user the content of the QR code.

20. (canceled)

21. (canceled)
